(19) United States
(12) Patent Application Publication
(10) Pub. No.: US 2004/0020365 A1
(43) Pub. Date: Feb. 5, 2004

(54) Filter

(76) Inventors: Carsten Hansen, Helsingborg (SE); Jan Bjeregard, Helsingborg (SE); Joakim Schackenborg, Helsingborg (SE)

Correspondence Address: Steven S. Payne, 8027 Iliff Drive, Dunn Loring, VA, 22027, US

(21) Appl. No.: 10/419,731

(22) Filed: Apr. 22, 2003

Related U.S. Application Data
(60) Provisional application No. 60/374,138, filed on Apr. 22, 2002.

(51) Int. Cl. B01D 46/00

(52) U.S. Cl. 95/280; 55/283; 55/284

(57) ABSTRACT

A filter arrangement and method for handling polluted air or gases are disclosed. The filter arrangement comprises a number of filter hoses received in a filter chamber. The filter has an inlet for receiving air from an industrial process and an outlet for cleaned air. Means are arranged to connect a limited group of the filter hoses to a cleaning fan, one group after another. The filter is cleaned by cleaning air which is blown into a limited group of filter hoses at a time.

### TECHNICAL FIELD

The present invention concerns a filter for handling polluted air or gases. There is a need for such filters in many different industrial processes. It also concerns a method for cleaning such filters.

Even if the present filter is developed for use in plants for paper products, such as diapers, tissue and towel, a person skilled in the art realises that the filter may be used in any type of industrial process. It may of course also be used for any polluted air, even if the air does not come from an industrial process, if suitable.

### PRIOR ART

It is known to have filters having several single filter hoses for collecting dust etc. in the process air. Existing filters function reasonably well, but there is room for improvement of separate parts.

One such problem is that the filter sometimes disturbs the industrial process. One common disturbance is that during e.g. cleaning a sudden pressure rise may be created in the filter arrangement. This increased pressure will influence the pressure of the incoming air and may disturb the industrial process as such. Sudden pressure drops may give a similar effect disturbing the process. Pressure variations of the process may lead to cassation of a larger or smaller amount of produced products. Thus, the pressure level of the filter arrangement should be as stable as possible.

In one example of the prior art the filter elements are formed of filter hoses, which are sewn to form three “pockets”. Inside of each of these pockets an I-profile is placed to keep the form of the filter hoses. Said I-profile is made of massive material increasing the flow resistance. Furthermore, the form with three pockets reduces the ability of the filter hoses to flex and thus get ride of dust particles during a cleaning cycle.

In the existing filters it is common to have an offline cleaning. Cleaning routines used in existing filters does not always succeed in removing enough of the dust, which may lead to dangerous levels of dust concentration. It is common to have a cloud of dust particles in a filter chamber, which dust particles does not settle. High levels of dust means that the risk of dust explosion is pronounced. The cleaning cycles of existing filter often leads to pressure variations that may be transferred to the industrial process proper. Pressure variations may lead to cassations as stated above.

One hazard with filters of the present kind is that dust explosions can occur. Explosions may occur if the following conditions exist simultaneously:

the dust is combustible

the dust concentration is within the explosion limits

there is a high degree of dust dispersion

the size of the dust particles is between 0.1 and 0.001 mm

there is a potentially dangerous volume, approximately more than 10 litres of a combustion atmosphere in enclosed rooms, regardless of the size of the room

there are effective sources of ignition of sufficient ignition energy.

In existing filter systems it is normal to design a protection system accepting an explosion and reducing the consequences by pressure venting or building the equipment for the maximum explosion pressure.

### SUMMARY OF THE INVENTION

It is a general aim to improve the characteristics of filter arrangements to be used for industrial processes. Some of these aims is to reduce the air flow resistance, improve cleaning of the filter elements, reduce the risk of a dust explosion. One further aim is to have a filter arrangement with a low demand for energy at the same time as it guarantees a stable airflow.

One object of the present invention is that the pressure level of the filter should be kept as constant as possible. According to the present invention this is achieved in that a filter arrangement comprising a number of filter hoses is used. Which filter hoses are received in a filter chamber. The filter has an inlet for receiving air from an industrial process and an outlet for cleaned air. Means are provided to connect a limited group of filter hoses to a cleaning fan, one group after the other. This means that the number of filter hoses that are cleaned and the number that are active are the same at any given point of time. Thus, the risk of pressure variations at the filter is substantially reduced.

According to a further aspect of the present invention the filter is designed to as much as possible avoid a dust concentration above the lowest explosion limit. This will reduce the risk of dust explosions.

Further objects and advantages of the present invention will become obvious for a person skilled in the art when reading the detailed description below.

### BRIEF DESCRIPTION OF THE DRAWINGS

One embodiment of the present invention will be described further below, by way of an example and by reference to the enclosed drawings. In the drawings:

FIG. 1 is a partly exploded view of a filter arrangement according to the present invention;

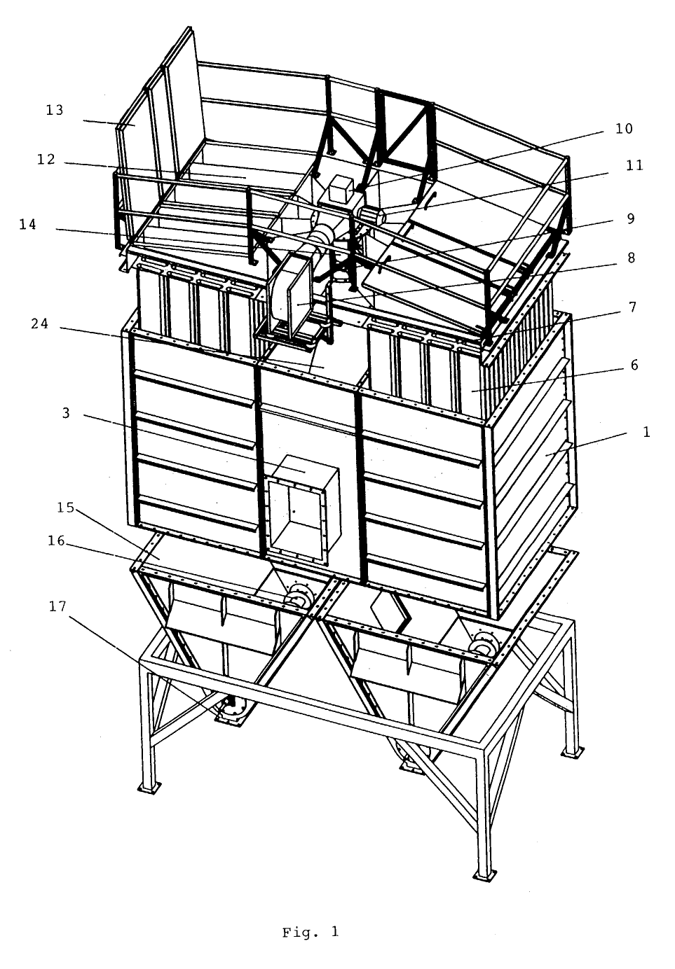

FIG. 2 is a perspective view of a part of the detail of FIG. 1;

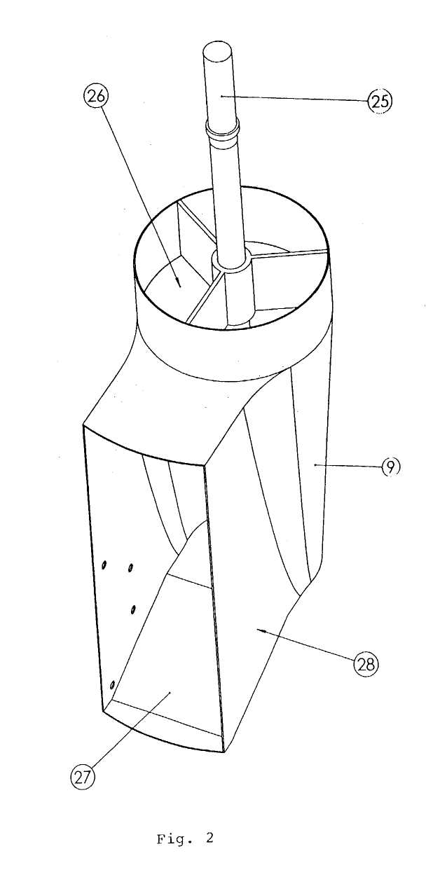

FIGS. 3a and 3b are front and side views, respectively of the filter arrangement of FIG. 1; and

FIG. 4 is a front view of a filter arrangement enclosing a system for the prevention of flames and explosion, which system is suitable for use with filters according to the present invention.

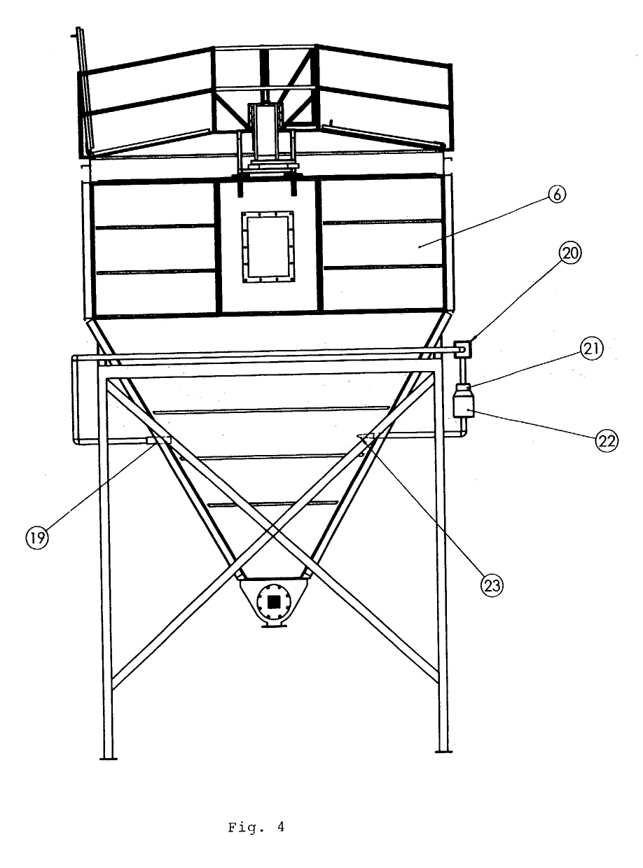

### DETAILED DESCRIPTION OF A PREFERRED EMBODIMENT

The filter arrangement according to the shown embodiment has a filter chamber or filter housing 1. The filter chamber 1 has an inlet 2, for receiving air from the process. The air from the process normally contains dust particles or the like, formed in the process. The filter chamber 1 also has an outlet 3, connected to a main fan (not shown). The main fan is preferably frequency-controlled to maintain a constant static pressure in the process, regardless of the number of connections or production lines that are opened/closed or started/stopped. By means of the main fan the process air is feed through the filter arrangement from the inlet 2 to the outlet 3. It is a constant negative pressure in the filter chamber 1.

The filter chamber 1 contains a number of filter hoses 6 in several rows. The rows of filter hoses 6 are placed on opposite sides of an outlet tubing 24. Each filter hose 6 is placed on and surrounding a filter cage 7. The filter cage 7 has the form of a wire basket. The cross section of the filter hoses 6 and the filter cages is elongated and rectangular. The filter hoses 6 are placed in such a way that their smallest dimension is placed in the normal flow direction of the filter. In this way the flow resistance of the filter is kept relatively small. Also the net form of the filter cages 7, assists in keeping the flow resistance at a relatively low level. A person skilled in the art realises that the present invention also could be used with filter hoses formed and arranged as according to the prior art.

Thanks to the elongated cross section of the filter hoses 6 and their cages 7 a better cleaning will result. This is due to more horizontal movement of the walls of the hoses 6 and less pressure drop across the filter hoses 6. Therefore, the air load of the filter can be increased compared to previously known filters having filter element with a round cross section.

Under the rows of filter hoses 6 a dust hopper 15 is arranged. The walls of the dust hopper 15 are inclined towards a worm conveyor 16 at the bottom. The worm conveyor 16 will transport collected dust towards a dust outlet 17. A person skilled in the art realises than any suitable means may be provided for transport or the collected dust to the dust outlet 17.

In a filter top 5 a number of compartments are arranged. The compartments are formed and separated by walls 12. Each compartment is in fluid connection with a set of filter hoses 6. The number of filter hoses 6 of each set connected to each compartment may vary. The exact form of the compartments is not critical, as long as each compartment has the same flow resistance etc. In the shown embodiment there are twelve filter hoses 6 connected to each compartment. The compartments have an opening for each filter hose 6, which opening is placed above a filter hose 6. Thus, the positions of said openings 13 are adapted to the positions of the filter hoses 6.

In the centre of the filter top 5 a rotor 9 is received in a rotor support 14. The rotor 9 will connect one compartment at the time with a cleaning fan. The walls 12 forming the compartments are directed towards the centre and are spaced to give room for the rotor 9.

A covering 4 is placed on top of the filter top 5, forming a ceiling for the compartments. On the covering 4 a cleaning fan 8 and a control unit 10 including a motor 11 are received. By means of the control unit 10 and the motor 11 the rotor 9 is controlled to give a suitable cleaning cycle. Normally the covering also has one or more inspection hatches 13 for control and filter change.

In use the polluted air comes into the filter via the inlet 2. The air will then be sucked through the filter hoses 6, whereby dust particles and the like will be collected on the filter hoses 6. From the filter hoses 6 the air will go up and into the compartments of the filter top 5 by means of the openings 13. From the compartments the air will go into the centre of the filter top 5 and down through the rotor support 14. From the rotor support 14 the air will go into the outlet tubing 24 and onto the outlet 3. A main fan (not shown) is placed downstream the outlet 3. It is the main fan, which draws the air through the filter. By means of the main fan and the form of the filter the filter chamber 1 will have a static negative pressure.

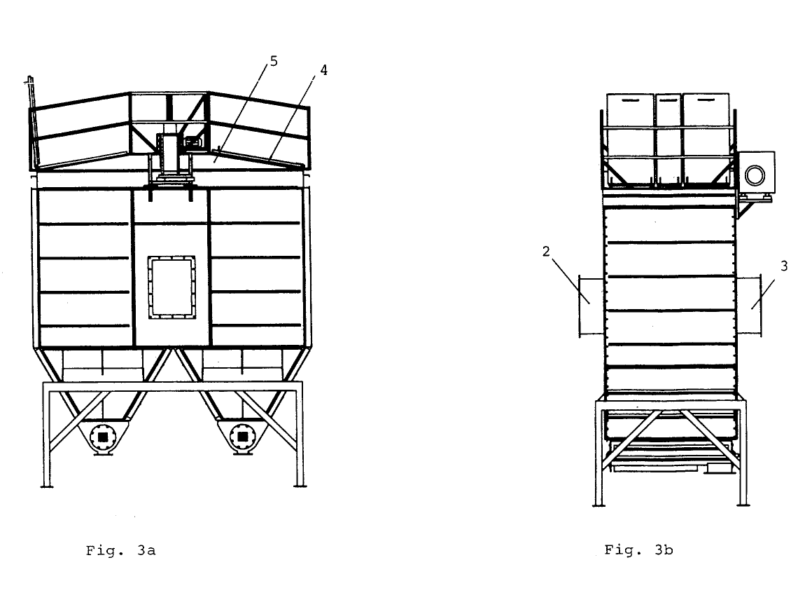

During the normal function of the filter one section of filter hoses 6 are successively cleaned. This is accomplished by means of the rotor 9 and the cleaning fan 8. The form of the rotor 9 is indicated in FIG. 3. The rotor 9 is mechanically connected to a control unit 10 by means of a shaft 25 at the upper part of the rotor 9. Furthermore, the rotor 9 has an inlet 26 and an outlet 27. The clean air inlet 26 is arranged at the top of the rotor 6, surrounding the shaft 25. The outlet 27 of the rotor 9 is directed sideways and is formed of a number of walls 28. The size and form of the outlet 27 of the rotor 9 is adapted to the form of the compartments of the filter top 5. The outlet 27 of the rotor is connected to one compartment at the time. The control unit 10 for the rotor 9 has a worm gear (not shown) connecting the shaft 25 of the rotor 9 with a motor 11. Furthermore, the control unit 10 is connected to a cleaning fan 8. A person skilled in the art will realises that the rotor may have any form enabling the cleaning fan to be connected to the compartments one at the time.

The cleaning fan 8 will forward air down through the inlet 26 of the rotor 9. Via the outlet 27 of the rotor 9 the air from the cleaning fan will go into the compartment currently in line with the outlet 27 of the rotor 9. The air will then go into the filter hoses 6 placed under the compartment by means of the openings 13 of said compartment. The air will then go through the filter hoses 6 in the opposite direction compared to the normal flow direction. This airflow in “wrong” direction will make the filter hoses to expand whereby the dust particles are ripped away. Due to the negative pressure of the filter chamber 1 and the power of the cleaning fan 8 the airflow will be rather powerful. The powerful airflow guarantees that the dust particles are forced away from the filter hoses 6 and will go down into the dust hopper 15. The airflow will support the dust particles in their movement towards the bottom of the dust hopper 15 and the worm conveyor 16. The rotor 9 will move intermittently between the compartments and thus, will be stationary for a period of time in position with a specific compartment. From the time the rotor 9 is in position at one compartment and until it moves on to the next compartment, the cleaning fan may be in use. The time period under which the cleaning fan 8 is blowing air into each compartment is relatively extended. In a normal case said time period is about 5 seconds.

Even tough it is preferred to use a cleaning fan, the cleaning would also function without any cleaning fan. This is due to the fact that the filter chamber 1 is at a static negative pressure. Thus, the filter hoses 6 will be drawn from the filter cages 7 when the rotor 9 breaks the direct connection to the main fan for the group of filter hoses 6 in question.

The most critical situation regarding the risk of a dust explosion in a filter of this kind is during cleaning of the filter hoses 6. The filter hoses in traditional filters are cleaned by a pulse of air at high pressure. The air pulse is given only for a short time period, which means that the falling dust risk to immediately be sucked back to the filter hoses. Therefore, the filter hoses may not be fully cleaned during the cleaning cycle. Furthermore, bridge building between the separate filter hoses is often the result, especially if the dust is sticky, with the effect of very high dust concentrations if these bridges brake during a cleaning cycle. The dust concentration in this case may be above the lowest explosion limit. If there is a spark of sufficient energy at the same time, the dust cloud may ignite.

According to the present invention the cleaning is done in a different way. The cleaning is done only in small sections and continuously section after section. The cleaning air stream lasts for a longer time period. The geometry of the filter hoses 6 allow more side movements of the hose walls and therefore a better cleaning is achieved. The separated falling dust is forced into the lower part of the hopper 15 by the cleaning fan 8. The filter hoses 6 are made of an antistatic material and the filter cages 7 are connected to earth. All this in combination is reducing the risk of reaching a dust concentration above the lowest explosion limit and the risk of ignition. Therefore, the risk of a dust explosion is substantially reduced compared to a traditional filter arrangement.

In spite of the above the filter arrangement of the present invention is furnished with a system for the prevention of flames and explosion. This system comprises one or more flame detectors 19, a control unit 20, a gas generator 21, a water container 22 and an outlet 23 for water mist. The flame detectors 19 are placed in the area under the filter hoses 6. The signals from the flame detectors 19 are received in a control unit 20. In practice a detected flame will be subjected to a water mist within approx. 50 ms or even faster. The control unit 20 is connected to a gas generator 21. The gas generator 21 is placed on a water container 22, which gas generator 21 when activated will increase the pressure in the water container 22. In one example the pressure is raised to 12 bar within 10 ms. To get a quick release of water a burst disc or the like is placed in the water mist outlet 23. Nozzles in the outlet 23 will form a water mist when the burst disc has been removed by means of the control unit 20. The mist preferably has water droplets of about 10 to 300 microns in size, which extinguishes a possible flame front effectively. The control unit 20 ensures that the filter process is stopped at the same time. A person skilled in the art realises that the same control unit may be used both for the system for prevention of flames and explosion and the total industrial process.

A person skilled in the art realises that a filter system may be formed having two or more separate sections with their own rotors 9, hoppers 15 etc.

A pressure sensor may be placed on either side of the filter to measure the difference of pressure of the filter. Preferably the pressure sensors are connected to control units of the filter and/or the industrial process.

We claim:

1. A filter arrangement comprising:
a number of filter hoses received in a filter chamber, which filter has an inlet for receiving air from an industrial process and an outlet for cleaned air;
means for connecting a limited group of filter hoses to a cleaning fan, one group after another.

2. The filter according to claim 1, wherein a main fan is placed downstream of the outlet of the filter, keeping the filter chamber at a negative pressure.

3. The filter according to claim 1, further comprising:
a filter top is placed above the filter chamber, said filter top having a number of compartments separated by walls and in fluid connection with a number of filter hoses, whereby each limited group of filter hoses is connected to one component each and that the compartments have openings placed in line with the filter hoses in such a way that one opening is placed over each filter hose.

4. The filter according to claim 3, wherein walls of the compartments are extended to a central position of the filter top in which the walls give room for a rotor, the rotor being received in a rotor support of the filter top, wherein the rotor has an inlet connected to a cleaning fan and an outlet which is connectable to one compartment at a time.

5. The filter according to claim 4, wherein the rotor is connected to a control unit connecting the rotor with the cleaning fan, and the control unit is connected to a motor for driving the rotor.

6. The filter according to claim 5, wherein the cleaning fan, the control unit including the motor are placed on top of a covering and the covering forms the top of the compartments of the filter top.

7. The filter according to claim 4, wherein the rotor is moved intermittently.

8. The filter according to claim 1, wherein the filter hoses have an elongated cross section.

9. The filter according to claim 8, wherein a filter cage in the form of a wire basket is received inside each filter hose, said filter cage having an elongated cross section.

10. The filter according to claim 1, further comprising:
at least one dust hopper arranged beneath the filter hoses in the filter chamber;
means for feeding collected dust of the at least one dust hopper towards a dust outlet.

11. The filter according to claim 10, wherein the feeding means are worm conveyors.

12. The filter according to claim 1, further comprising:
means for prevention of flames and explosions being arranged in connection with the filter chamber.

13. The filter according to claim 12, wherein the means for prevention of flames and explosions comprises at least one flame detector, a water container, a gas generator arranged in communication with the interior of the water container, a water mist outlet of the water container and a control unit.

14. The filter according to claim 13, wherein nozzles are arranged in connection with the water mist outlet to form a water mist, the water mist outlet is furnished with means for swift opening, wherein the gas generator will increase the pressure of the water in the water container when activated and the at least one flame detector and the gas generator are in communication with a control unit.

15. The filter according to claim 14, wherein the means for swift opening is a burst disc and the control unit is a control unit for the industrial process.

16. A method for cleaning a filter according to claim 1, wherein cleaning air is blown into a limited group of filter hoses at a time.

17. The method according to claim 16, wherein the cleaning air is blown during approximately 5 seconds for each limited group of filter hoses.

18. The method according to claim 16, wherein a rotor is used to connect each limited group of filter hoses with a cleaning fan.
